(19) United States
(12) Patent Application Publication
(10) Pub. No.: US 2026/0073225 A1
(43) Pub. Date: Mar. 12, 2026

(54) EFFICIENT LOW-RANK BACKPROPAGATION FOR VISION TRANSFORMER ADAPTATION

(71) Applicant: Board of Regents, The University of Texas System, Austin, TX (US)

(72) Inventors: Radu Marculescu, Austin, TX (US); Yuedong Yang, Austin, TX (US); Guihong Li, Austin, TX (US); Hung-Yueh Chiang, Austin, TX (US); Diana Marculescu, Austin, TX (US)

(73) Assignee: Board of Regents, The University of Texas System, Austin, TX (US)

(21) Appl. No.: 19/290,686

(22) Filed: Aug. 5, 2025

Related U.S. Application Data
(60) Provisional application No. 63/679,758, filed on Aug. 6, 2024.

(51) Int. Cl. G06N 3/084; G06F 17/16; G06N 3/0455

(52) U.S. Cl. CPC G06N 3/084; G06F 17/16; G06N 3/0455

(57) ABSTRACT

A system for data processing, comprising a transformer system operating on a processor and configured to receive data sets and to process the data sets to generate a transformer data structure. A low rank space projection system operating on the processor and coupled to the transformer system, the low rank space processing system configured to convert input data into low rank space input data. A matrix multiplication system operating on the processor and coupled to the low rank space projection system, the matrix multiplication system configured to receive the low rank space input data to perform a matrix multiplication process on the low rank space input data to generate low rank space output data.

### RELATED APPLICATIONS

This application claims benefit of and priority to U.S. provisional patent application No. 63/679,758, filed Aug. 6, 2024, which is hereby incorporated by reference as if set forth herein in its entirety.

This invention was made with government support under Grant no. CNS2007284 awarded by the National Science Foundation. The government has certain rights in the invention.

### TECHNICAL FIELD

The present disclosure relates generally to data processing, and more specifically to efficient transformer data processing.

### BACKGROUND OF THE INVENTION

Transformers can perform specialized data processing but require a large amount of computing resources.

### SUMMARY OF THE INVENTION

A system for data processing is disclosed that includes a transformer system operating on a processor and configured to receive data sets and to process the data sets to generate a transformer data structure. A low rank space projection system operating on the processor is coupled to the transformer system and configured to convert input data into low rank space input data. A matrix multiplication system operating on the processor is coupled to the low rank space projection system and is configured to receive the low rank space input data to perform a matrix multiplication process on the low rank space input data to generate low rank space output data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a process for performing back propagation for gradients with respect to inputs and weights in a low-rank space, in accordance with an example embodiment of the present disclosure;

FIG. 2 is a diagram of workflows, in accordance with an example embodiment of the present disclosure;

FIG. 3 is a diagram of a transformation basis for an order-4 WHT, in accordance with an example embodiment of the present disclosure;

FIG. 4 is a diagram of a system for low-rank space analysis, in accordance with an example embodiment of the present disclosure; and

FIG. 5 is a diagram of an algorithm for low-rank matrix analysis, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

This application claims benefit of and priority to U.S. provisional patent application No. 63/679,758, filed Aug. 6, 2024, which is hereby incorporated by reference as if set forth herein in its entirety.

Deep learning models are important technological innovations, but they have associated computational costs that are substantial, which imposes limits on their use and generates associated environmental costs when they are used. The present disclosure pertains to systems and methods that implement low-rank backpropagation (BP) via Walsh-Hadamard Transformation (LBP-WHT), which is used to adapt Vision Transformers (ViTs) (sometimes referred to as computer vision systems or in other similar manners) for specialized tasks. The present disclosure provides numerous technical features and advances, such as significantly reducing the computational costs involved in the BP process, which is a key component of the computational costs incurred when training deep learning models.

One important aspect of the disclosed systems and methods for implementing LBP-WHT involves projecting gradients into a low-rank space using the Walsh-Hadamard Transformation. The present disclosure recognizes that this projection can be used to achieve a substantial reduction in computational resources needed for implementation of deep learning models, thus making it particularly advantageous for adapting large-scale ViT models to devices with limited computational capabilities. In this manner, the cost of the devices needed to implement large-scale ViT models can be reduced, allowing the large-scale ViT models to be implemented for more applications.

One practical application of the present disclosure is its application in fields where advanced image processing and analysis are required, but where there are significant computation and hardware constraints. For example, large-scale ViT models for applications that require mobile computing, robotics, edge computing/IoT and so forth can be restricted, because deploying large, sophisticated neural network models is not possible due to device resource constraints. The disclosed LBP-WHT systems and methods enable such applications through efficient model training and adaptation, without compromising the performance and accuracy of the ViTs.

The disclosed LBP-WHT systems and methods reduce computational costs in BP for ViTs by employing a low-rank projection of gradients using the Walsh-Hadamard Transformation. This approach is distinctive because it enables the performance and accuracy of large ViT models to be maintained while significantly reducing the computational resources required. Existing technologies typically require extensive computational power to train and adapt large neural network models, which is a key limitation that LBP-WHT addresses.

The disclosed systems and methods for LBP-WHT solve several critical problems in the field of deep learning, particularly in the adaptation of ViTs. One of the primary problems that are solved is improved computational efficiency from reduction of the computational resources required for training and adapting large ViT models, which makes it feasible to use these models in environments with limited computational power, like mobile or edge devices. Another primary problem is scalability. The disclosed systems and methods provide for the scalability of advanced neural network models in resource-constrained settings by enabling efficient training and adaptation with reduced computational demands. The disclosed systems and methods also enhance the practical deployment of sophisticated ViT models in real-world applications where computational resources are a limiting factor.

In contrast to existing technologies that require high computational power, the disclosed LBP-WHT systems and methods provide a more efficient approach, broadening the applicability of advanced neural network models. The LBP-WHT systems and methods can also be used with other deep learning architectures by adaptation of the systems and methods for other types of neural networks, beyond ViTs. Data-intensive domains can also benefit from the use of the disclosed systems and methods, such as in areas like healthcare, autonomous vehicles, and IoT, where efficient processing of large data sets is crucial. The disclosed systems and method implement energy-efficient computing for application in energy-constrained environments, contributing to more sustainable AI practices.

The increasing scale of ViT has made the efficient fine-tuning of these large models for specific needs a significant challenge in various applications. This problem reflects the computationally demanding matrix multiplications required during the BP process through linear layers in ViT. To solve this problem, the disclosed LBP-WHT systems and methods project the gradients associated with ViT layer weights into a low-rank space to carry out BP. This approach substantially reduces the computation needed for adapting ViT, as matrix multiplication in the low-rank space is far less resource-intensive. Experiments with different models (ViT, hybrid convolution-ViT model) on multiple datasets have demonstrated the effectiveness of the present disclosure. For instance, when adapting an EfficientFormer-L1 model on CIFAR100, the disclosed LBP-WHT systems and methods achieve 10.4% higher accuracy than the baseline, while requiring 9 MFLOPs less computation. As the first embodiment to accelerate ViT adaptation with low-rank BP, the disclosed LBP-WHT systems and methods are complementary to many existing hardware applications and can be combined with them for better performance.

Adapting ViT models via finetuning demands considerable computational resources and is often impractical for most edge applications. For instance, to maintain privacy in federated learning, model adaptation is limited to users' personal edge devices (e.g., smartphones), where computational power is tightly restricted.

The primary computational bottleneck arises from gradient propagation through the dense layers of ViT. Specifically, calculating gradients for layer weights and inputs requires two computationally-intensive matrix multiplications, given the gradient for output. To tackle this issue, simplification of matrix multiplications using low-rank reparametrization has been tried. However, this approach only reduces the gradient computation for weights and not for inputs, thus limiting the overall speedup. The present disclosure decreases the computational cost for all operations, including gradient computations for weights and inputs, involved in BP through any suitable linear layer in the ViT model.

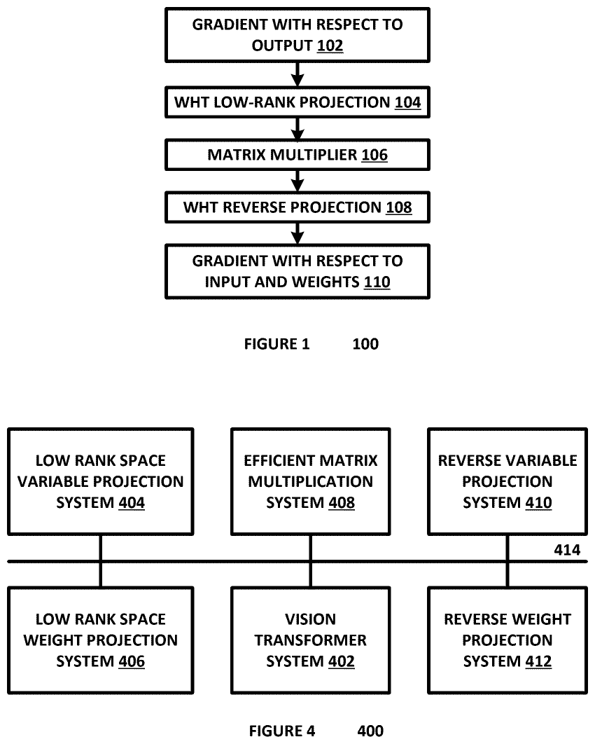

FIG. 1 is a diagram of a process 100 for performing BP for gradients with respect to inputs and weights in a low-rank space, in accordance with an example embodiment of the present disclosure. Process 100 can be implemented in hardware or a suitable combination of hardware and software.

Process 100 includes a first system 102 that projects the gradient with respect to the output into a second system 104 that generates a low-rank space using WHT. A third system 106 performs low-rank matrix multiplications, and a fourth system 108 projects the results back to a fifth system 110 that applies the gradient with respect to the input and weights. In this manner, all matrix multiplications occur in a low-rank space, and the computational cost is significantly reduced.

The disclosed LBP-WHT systems and methods implement a new approach that greatly reduces the computational cost for adapting ViT while maintaining accuracy, lowers the computational barriers for ViT and enables adapting large ViT models on resource constrained edge devices. The disclosed LBP-WHT systems and methods are the first to accelerate ViT training by low-rank BP. LBP-WHT is orthogonal to prior works and can be combined with them for a better performance. Additionally, LBP-WHT offers abundant flexibility that can provide a good tradeoff between accuracy and cost. Extensive experiments on multiple datasets have demonstrated the effectiveness of the disclosed LBP-WHT systems and methods, which consistently outperform the baseline system and methods both in accuracy and speed. For instance, the disclosed LBP-WHT systems and methods achieve 10.4% higher accuracy, while requiring 9 MFLOPs less computation for training EfficientFormer-L1 on a CIFAR100 dataset.

In this disclosure, feature maps can be treated as matrices composed of real numbers, with dimensions R^{C×L}, where C represents the number of rows and L denotes the number of columns. Each row in the matrix can be regarded as a “channel” consisting of L elements, where there are a total of C channels in the feature map. Subscripts can be used to identify specific variables, such as Cₓ for the number of channels associated with variable x. Gradients with respect to x are denoted by gₓ, with the subscript indicating the target variable x.

The BP process for linear layers is an important building block for vision transformers. Given an input x∈R^{C}^{ₓ}^{×L} and weights w∈R^{C}^{_{y}}^{×C}^{ₓ}, the forward propagation to compute the output y∈R^{C}^{_{y}}^{×L} can be expressed as:

y=x·w^{T} (1)

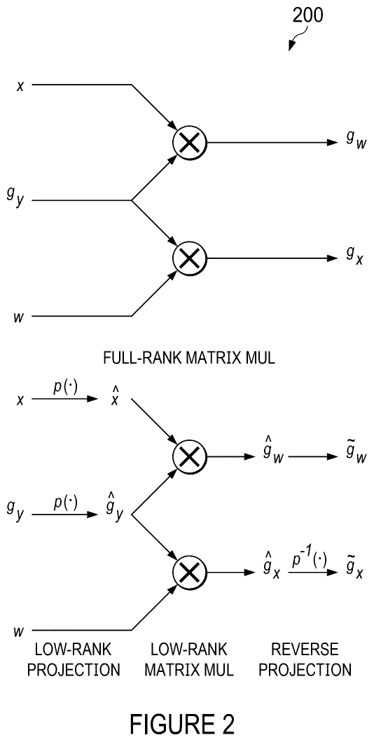

FIG. 2 is a diagram of workflows 200, in accordance with an example embodiment of the present disclosure. Given the gradient with respect to the output y, i.e., g_{y}∈R^{C}^{_{y}}^{×L}, the back-propagation for computing the gradient with respect to the weights w, g_{w}∈R^{C}^{_{y}}^{×C}^{ₓ}, and the gradient with respect to the input x, gₓ∈R^{C}^{ₓ}^{×L}, can be represented as two matrix multiplications:

$$\begin{matrix}{g}_{w} = {g}_{y} \cdot x \\ {g}_{x} = {g}_{y} \cdot w\end{matrix} \qquad ( 2 )$$

The gradient w.r.t. the weight (g_{w}) is utilized for updating the weights w, while the gradient w.r.t. the input (gₓ) is employed for propagating the gradient to other layers. During the BP process, each matrix multiplication incurs a computational cost of 2CₓC_{y}L FLOPs, which amounts to 4CₓC_{y}L FLOPs, in total. Given that in ViT models, the number of channels (Cₓ and C_{y}) and the length of the input feature map (L) are substantial, the computational cost for BP becomes significant. The disclosed LBP-WHT systems and methods reduce the computational cost for both matrix multiplications by employing low-rank approximations.

Specifically, variables can be projected into a low-rank space as follows:

$$g {\hat{}}_{y} = p ( {g}_{y} ) , x \hat{}= p ( x ) \qquad ( 3 )$$

Here, ĝ_{y}∈R^{C}^{_{y}}^{×R} and \hat{x}∈R^{C}^{ₓ}^{×R} represent the low-rank space projections (R<<L) for the gradient with respect to the output (g_{y}) and input x, respectively. The projection function p(·) is discussed below.

Next, execute the BP through the linear layer in the low-rank spaces as follows:

$$g {\hat{}}_{w} = g {\hat{}}_{y} \cdot x \hat{} , g {\hat{}}_{x} = g {\hat{}}_{y} \cdot w \qquad ( 4 )$$

Finally, the low-rank gradient is projected with respect to the input (ĝₓ) back into its original space. The reverse projection for ĝ_{w} can be omitted as it already exists in the same space R^{C}^{_{y}}^{C}^{ₓ} as the target g_{w}. For ĝₓ, the reverse projection is accomplished using the function p⁻¹ (·), the details of which are discussed below:

$$\begin{matrix}{g}_{w}^{∼} = g {\hat{}}_{w} , & {g}_{x}^{∼} = {p}^{- 1} ( g {\hat{}}_{x} )\end{matrix} \qquad ( 5 )$$

Here, \tilde{g}_{w} and \tilde{g}ₓ represent the resulting gradients for weights and input. As these gradients are generated through an approximated back-propagation process rather than the standard BP, these variables are denoted with tildes.

As shown in workflows 200, the computational cost is reduced by performing back-propagation in a low-rank space, as described in Eq. 4. For instance, using a rank R approximation, each matrix multiplication requires 2CₓC_{y}R FLOPS, which can be substantially smaller than 2CₓC_{y}L when R<<L. Nevertheless, this approach necessitates two additional steps, projection and reverse projection (as illustrated in Eqs. 3 and 5), which introduce some computational overhead. Furthermore, the low-rank projection may add noise and potentially diminish the quality of training. To address these concerns, the present disclosure incorporates a low-overhead projection function based on the WHT and tackles the second issue by selecting an appropriate set of WHT bases.

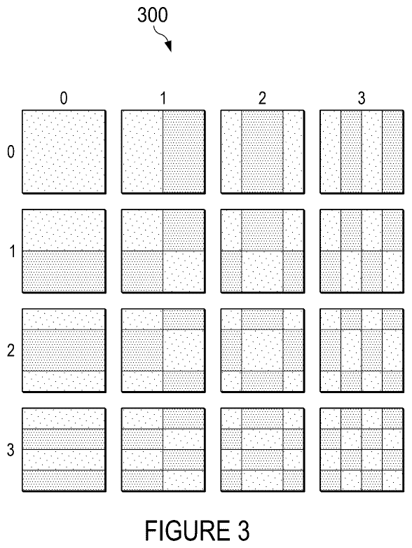

FIG. 3 is a diagram 300 of a transformation basis for an order-4 WHT, in accordance with an example embodiment of the present disclosure. WHT is a generalized Fourier transformation. For an order-n 2D WHT, there are n×n bases B_{i,j}, with each basis being an n×n matrix containing only +1 and −1. Of note, in the context of ViT, 2D feature maps are flattened into 1D maps, so a flattened WHT base is utilized—a vector with a length of n², i.e., B_{i,j}∈Zⁿ^{₂}^{×1}, 0≤i,j<n. WHT possesses four properties that make it advantageous. First, the transformation bases are complete. Second, the transformation bases are orthogonal. Third, the transformation bases contain only +1 and −1. Fourth, the transformation cost can be reduced via fast WHT algorithm with O(n log n) complexity.

The first property (completeness) allows WHT to perform transformations ranging from lossy (when few bases are activated) to lossless (when all bases are activated). This property grants flexibility in exploring the trade-off between efficiency and accuracy. The second property ensures that any variable has precisely one projection result, obtainable via matrix multiplication. For instance, the projection function for g_{y} (Eq. 3) with basis B_{i,j} can be expressed as p(g_{y})=g_{y}·B_{i,j}. Likewise, the reverse projection can also be implemented using a simple matrix multiplication. The third and final properties demonstrate the efficiency of WHT implementation, requiring only O (n log n) additions/subtractions and no multiplications.

These four properties demonstrate that WHT provides both low overhead and high flexibility for selecting an appropriate set of bases. Therefore, WHT can be employed as the projection function p(·) and reverse projection function p⁻¹(·) in Eqs. 3 and 5. More specifically, for an order −nWHT with a set of R bases chosen by an index set I, the projection function can be written as:

p(x)=WHT(x;I)=x·(Bᵢ_{₁}_{,j}_{₁}Bᵢ_{₂}_{,j}_{₂} . . . Bᵢ_{_{R}}_{,j}_{_{R}}),(iₖ,jₖ)∈I,1≤k≤R (6)

where I={(iₖ,jₖ)|1≤iₖ,jₖ≤n, 1≤k≤R} indicates which bases are activated. Similarly, the reverse projection function can be expressed as:

$${p}^{- 1} ( x ) = {WHT}^{- 1} ( x ; ℐ ) = x \cdot \begin{matrix}( {B}_{{i}_{1} , {j}_{1}} & {B}_{{i}_{2} , {j}_{2}} & … & {{B}_{{i}_{r} , {j}_{r}} )}^{T} , ( {i}_{k} , {j}_{k} ) ∈ ℐ\end{matrix} , 1 \leq k \leq r \qquad ( 7 )$$

For simplicity, both Eqs. 6 and 7 are presented using the vanilla WHT algorithm with computational complexity O(n²), rather than the fast WHT algorithm with complexity O(n log n). Consequently, the disclosed LBP-WHT systems and methods can use an algorithm that can be summarized as Algorithm 1 also shown in workflows 200.

Algorithm 1 Backpropagation through a linear layer with LBP-WHT.

Input: Input x, weight w, gradient w.r.t. output g_{y}, Selected WHT base indices I
Output: Approximated gradient w.r.t. input \tilde{g}ₓ, approximated gradient w.r.t. weight \tilde{g}_{w}

| | |
|---|---|
| \hat{x} ← p(x) = WHT (x; I) | [symbol] Projection to a low-rank space with WHT (Equation 3) |

ĝ_{y} ← p(g_{y}) = WHT(g_{y}; I)

| | |
|---|---|
| ĝ_{w} ← ĝ_{y}^{T} · \hat{x} | [symbol] Efficient matrix multiplication in a low-rank space (Equation 4) |

ĝₓ ← ĝ_{y} · w
\tilde{g}ₓ ← p⁻¹(ĝₓ) = WHT⁻¹(ĝₓ; I) [symbol] Reverse projection to a full-rank space (Equation 5)

| | |
|---|---|
| \tilde{g}_{w} ← ĝ_{w} | [symbol] Skipped reverse projection since g_{w} is already in full-rank space |

Given an input for BP, first project x and g_{y} into low-rank space (Eq. 3), then perform matrix multiplication (Eq. 4) and lastly project the results back (Eq. 5).

Two types of basis selection strategies can be used: low-pass and low-heuristic-error. For low-pass (LP) base selection, natural images have strong spatial locality, i.e., pronounced low frequency components. Taking advantage of this feature, bases with stronger low-frequency responses are chosen, which have smaller indices as illustrated in diagram 300. More specifically, both L₁-based and L_{∞}-based low-pass basis selection strategies (LP_{L}_{₁} and LP_{L}_{_{∞}}) can be considered:

$${ℐ}_{{L}_{1}} = \{ ( {i}_{k} , {j}_{k} ) \vert \vert {i}_{k} \vert + \vert {j}_{k} \vert \leq {r}_{{L}_{1}} , 1 \leq {i}_{k} , {j}_{k} \leq n , \frac{1}{2} {r}_{{L}_{1}} ( 1 + {r}_{{L}_{1}} ) = r \} , {LP}_{{L}_{1}} selection \qquad ( 8 )$$

$${ℐ}_{{L}_{∞}} = \{ ( {i}_{k} , {j}_{k} ) \vert max ( {i}_{k} , {j}_{k} ) \leq {r}_{{L}_{∞}} , 1 \leq {i}_{k} , {j}_{k} \leq n , {r}_{{L}_{∞}}^{2} = r \} , {LP}_{{L}_{∞}} selection \qquad ( 9 )$$

I_{L}_{₁} and I_{L}_{_{∞}} are the index sets for selecting WHT bases, as described in Section 3.1. For example, with LP_{L}_{₁}-2 base selection, three bases are chosen, i.e., I_{L}_{₁}={(0,0), (0,1), (1,0)}, and the rank for projection, namely R, is three.

Low-heuristic-error (LHE) Base Selection: According to Parseval's Theorem, WHT preserves the signal energy, so by selecting the WHT bases with the top-r strongest responses, the most energy can be preserved during low-rank projection and the error can also be minimized. Since profiling the energy for all WHT bases on all training steps is expensive, the energy for all WHT bases is profiled only for a small number of training steps and the bases with the top-R energy are selected.

Considering that the L₁-based low-pass basis selection has a much lower profiling overhead than the low-heuristic-error basis selection and provides finer granularity in balancing accuracy and efficiency, a primary focus can be placed on the LP_{L}_{₁} selection method, but other example embodiments are also discussed below.

Since the computational cost for the fast WHT algorithm depends on the basis selection, the analysis can be simplified by considering the matrix multiplication-based vanilla WHT algorithm, as shown in Eqs. 6 and 7. Table 1 presents the computation requirements for a linear layer with input and output channels Cₓ and C_{y}, feature map size L, and the rank for low-rank WHT approximation r. The disclosed LBP-WHT systems and methods achieve an L/r times speedup with an overhead of (2Cₓ+C_{y}) LR FLOPS, which is only

$$\frac{( 2 {C}_{x} + {C}_{y} ) LR}{4 {C}_{x} + {C}_{y} L} or ( \frac{1}{{C}_{x}} + \frac{1}{2 {C}_{y}} ) \frac{R}{2}$$

of the total computation required by vanilla BP. Given that ViT typically has a large number of channels, the overhead is very small.

TABLE 1
Computation required by Vanilla BP and components in our
LBP-WHT. We consider the projection and reverse projection
as overhead. “MM” is short for “Matrix Multiplication”.

| | FLOPs |
|---|---|
| Vanilla BP | 4CₓC_{y}L |
| Projection | (Cₓ + C_{y})Lr |
| Low-rank MM | 4CₓC_{y}r |
| Reverse Projection | CₓLr |

For instance, the final linear layer in SwinV2-small consists of 3072 input channels, 768 output channels, and a feature map size of 49, which means Cₓ=3072, C_{y}=768, and L=49. As per Table 1, conventional backpropagation (BP) requires 462.3 MFLOPs. In contrast, the disclosed Low-Rank Backpropagation with WHT (LBP-WHT) method, assuming a rank of 8 (R=8), needs only 78.2 MFLOPs, which is roughly 16.9% of the computation required by vanilla BP.

Breaking down the 78.2 MFLOPs for LBP-WHT, we see that 1.5 MFLOPs are needed for the low-rank projection, 75.5 MFLOPs for BP in the low-rank space, and 1.2 MFLOPS for the reverse projection. The combined overhead is 2.7 MFLOPs, accounting for just 0.6% of vanilla BP's computation and 3.5% of LBP-WHT's computation. This demonstrates that with WHT, we can significantly reduce the computation for BP while incurring negligible overhead for low-rank projection.

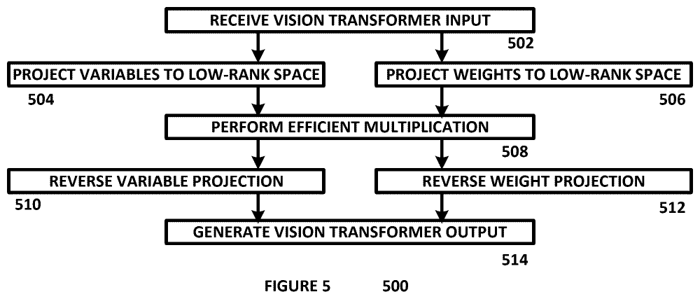

FIG. 4 is a diagram of a system 400 for low-rank space analysis, in accordance with an example embodiment of the present disclosure. System 400 includes vision transformer system 402, low-rank space variable projection system 404, low-rank space weight projection system 406, efficient matrix multiplication system 408, reverse variable projection system 410, reverse weight projection system 412 and data communications medium 414, each of which can be implemented in hardware or a suitable combination of hardware and software.

Vision transformer system 402 can be implemented as one or more algorithms stored to a working data memory of a processor that cause the processor to configure its arithmetic logic unit and associated registers to perform vision transformer processing of image data. In one example embodiment, vision transformer system 402 can perform image data processing for image classification, object detection, video deep fake detection, image segmentation, anomaly detection, image synthesis, cluster analysis, autonomous driving or other suitable purposes, such as where vision transformer system 402 receives a stream of image data sets and analyses the image data sets to identify components or objects in the image data, to associate the image data with metadata, to generate data for an application or for other suitable purposes. Vision transformer system 402 can interface with low-rank space variable projection system 404, low-rank space weight projection system 406, efficient matrix multiplication system 408, reverse variable projection system 410 and reverse weight projection system 412 over data communications medium 414, as discussed and described in further detail herein. While vision transformer system 402 is disclosed as an example embodiment, a person of skill in the art will recognize that other suitable functions as disclosed and discussed herein can also or alternatively be performed, such as large language model transformers, biological data processing, music data processing and so forth.

Low-rank space variable projection system 404 can be implemented as one or more algorithms stored to a working data memory of a processor that cause the processor to configure its arithmetic logic unit and associated registers to generate a low-rank space variable projection. In one example embodiment, the low-rank space variable projection can be a matrix with C rows and L columns, where each row in the matrix can be regarded as a ‘channel’ consisting of L elements, and there are a total of C channels in the feature map. Subscripts can be used to identify specific variables, such as Cₓ, for the number of channels associated with variable x. Gradients with respect to x can be denoted by gₓ, with the subscript indicating the target variable x. The input “x” can be represented as gₓ∈R^{C}^{ₓ}^{×L}, as discussed and described further herein, or in other suitable manners.

Low-rank space weight projection system 406 can be implemented as one or more algorithms stored to a working data memory of a processor that cause the processor to configure its arithmetic logic unit and associated registers to generate a low-rank weight variable projection. In one example embodiment, the weights “w” can be represented as g_{w}∈R^{C}^{_{y}}^{×C}^{ₓ}, as discussed and described further herein, or in other suitable manners.

Efficient matrix multiplication system 408 can be implemented as one or more algorithms stored to a working data memory of a processor that cause the processor to configure its arithmetic logic unit and associated registers to perform matrix multiplications. In one example embodiment, efficient matrix multiplication system 408 can receive inputs and weights and can perform calculations such as g_{w}=g_{y}·x and gₓ=g_{y}·w, as discussed and described further herein.

Reverse variable projection system 410 can be implemented as one or more algorithms stored to a working data memory of a processor that cause the processor to configure its arithmetic logic unit and associated registers to project variables into a low-rank space, such as using Eqs. (3), (4), (5), (6) and (7), as discussed and described further herein.

Reverse weight projection system 412 can be implemented as one or more algorithms stored to a working data memory of a processor that cause the processor to configure its arithmetic logic unit and associated registers to project weights into a low-rank space, such as using Eqs. (3), (4), (5), (6) and (7), as discussed and described further herein.

FIG. 5 is a diagram of an algorithm 500 for low-rank matrix analysis, in accordance with an example embodiment of the present disclosure. Algorithm 500 can be implemented in hardware or a suitable combination of hardware and software.

Algorithm 500 begins at 502, where vision transformer input is received. In one example embodiment, the vision transformer input can be an array of real numbers or other suitable data. Alternatively, the data can be large language model transformer input data, biological transformer input data or other suitable data. The algorithm then proceeds to 504 and 506, either in parallel as shown, serially or in other suitable manners.

At 504, variables associated with the vision transformer input are projected to a low rank space. In one example embodiment, low-rank space variable projection can be performed on a matrix with C rows and L columns, where each row in the matrix can be regarded as a ‘channel’ consisting of L elements, and there are a total of C channels in the feature map. Subscripts can be used to identify specific variables, such as Cₓ, for the number of channels associated with variable x. Gradients with respect to x can be denoted by gₓ, with the subscript indicating the target variable x. The input “x” can be represented as gₓ∈R^{C}^{ₓ}^{×L}, as discussed and described further herein, or in other suitable manners. The algorithm then proceeds to 508.

At 506, weights associated with the vision transformer input are projected to low rank space. In one example embodiment, the weights “w” can be represented as g_{w} ∈R^{C}^{_{y}}^{×C}^{ₓ}, as discussed and described further herein, or in other suitable manners. The algorithm then proceeds to 508.

At 508, efficient matrix multiplication is performed. In one example embodiment, efficient matrix multiplication can be performed by receiving the low-rank space projected inputs and weights and can perform calculations such as g_{w}=g_{y}·x and gₓ=g_{y}·W, as discussed and described further herein. The algorithm then proceeds to 510 and 512 in parallel as shown, serially or in other suitable manners.

At 510, reverse projection of variables is performed. In one example embodiment, variables can be projected into a low-rank space, such as using Eqs. (3), (4), (5), (6) and (7), as discussed and described further herein.

At 512, reverse projection of weights is performed. In one example embodiment, weights can be projected into a low-rank space, such as using Eqs. (3), (4), (5), (6) and (7), as discussed and described further herein.

At 514, vision transformer output is generated from the reverse projection corrected variables and weights. In one example embodiment, the vision transformer output can be generated by further processing the reverse projection corrected variables and weights in a suitable vision transformer process, as discussed and described further herein.

In operation, algorithm 500 performs low-rank matrix analysis, such as for vision transformer functions or other suitable functions as disclosed and discussed herein. While algorithm 500 is shown as a flow chart, a person of skill in the art will recognize that it can also or alternatively be implemented using one or more of objected-oriented programming paradigms, state diagrams, ladder diagrams or in other suitable manners.

In addition, additional enabling disclosure and some example embodiments can be found in Yang, Yuedong, et al. “Efficient low-rank backpropagation for vision transformer adaptation,” Advances in Neural Information Processing Systems 36 (2024), which is hereby incorporated by reference for all purposes and which is set forth in Appendix 1.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for data processing, comprising:
a transformer system operating on a processor and configured to receive data sets and to process the data sets to generate a transformer data structure;
a low rank space projection system operating on the processor and coupled to the transformer system, the low rank space processing system configured to convert input data into low rank space input data; and
a matrix multiplication system operating on the processor and coupled to the low rank space projection system, the matrix multiplication system configured to receive the low rank space input data to perform a matrix multiplication process on the low rank space input data to generate low rank space output data.

2. The system of claim 1 further comprising a reverse projection system operating on the processor and configured to receive the low rank space output data and to perform a reverse projection process on the low rank space output data to generate reverse projected output data.

3. The system of claim 2, wherein the transformer system is configured to receive the reverse projected output data and to process the data sets to generate a transformer output data.

4. The system of claim 1 wherein the a low rank space projection system comprises a low rank space variable projection system operating on the processor and coupled to the transformer system, the low rank space variable projection system configured to convert input variable data into low rank space input variable data.

5. The system of claim 1 wherein the a low rank space projection system comprises a low rank space weight projection system operating on the processor and coupled to the transformer system, the low rank space weight projection system configured to convert input weight data into low rank space input weight data.

6. The system of claim 1 further comprising a reverse projection variable system operating on the processor and configured to receive the low rank space output data and to perform a reverse projection variable process on the low rank space output data to generate reverse projected variable output data.

7. The system of claim 1 further comprising a reverse projection weight system operating on the processor and configured to receive the low rank space output data and to perform a reverse projection weight process on the low rank space output data to generate reverse projected weight output data.

8. A method for data processing, comprising:
receiving data sets at a transformer system operating on a processor and processing the data sets to generate a transformer data structure;
converting input data into low rank space input data using a low rank space projection system operating on the processor and coupled to the transformer system; and
receiving the low rank space input data at a matrix multiplication system operating on the processor and coupled to low rank space projection system performing a matrix the multiplication process on the low rank space input data to generate low rank space output data.

9. The method of claim 8 further comprising receiving the low rank space output data at a reverse projection system operating on the processor and performing a reverse projection process on the low rank space output data to generate reverse projected output data.

10. The method of claim 9, further comprising receiving the reverse projected output data with the transformer system and processing the data sets using the reverse projected output data to generate a transformer output data.

11. The method of claim 8 further comprising converting input variable data into low rank space input variable data using a low rank space variable projection system operating on the processor and coupled to the transformer system.

12. The method of claim 8 further comprising converting input weight data into low rank space input weight data using a low rank space weight projection system operating on the processor and coupled to the transformer system.

13. The method of claim 8 further comprising receiving the low rank space output data at a reverse projection variable system operating on the processor and performing a reverse projection variable process on the low rank space output data to generate reverse projected variable output data.

14. The method of claim 8 further comprising receiving the low rank space output data at a reverse projection weight system operating on the processor and performing a reverse projection weight process on the low rank space output data to generate reverse projected weight output data.

15. A system for data processing, comprising:
a transformer system operating on a processor and configured to receive data sets and to process the data sets to generate a transformer data structure;
a low rank space projection system operating on the processor and coupled to the transformer system, the low rank space processing system configured to convert input data into low rank space input data;
a matrix multiplication system operating on the processor and coupled to the low rank space projection system, the matrix multiplication system configured to receive the low rank space input data to perform a matrix multiplication process on the low rank space input data to generate low rank space output data; and
a reverse projection weight system operating on the processor and configured to receive the low rank space output data and to perform a reverse projection weight process on the low rank space output data to generate reverse projected weight output data.

16. The system of claim 15 further comprising a reverse projection system operating on the processor and configured to receive the low rank space output data and to perform a reverse projection process on the low rank space output data to generate reverse projected output data.

17. The system of claim 16, wherein the transformer system is configured to receive the reverse projected output data and to process the data sets to generate a transformer output data.

18. The system of claim 15 wherein the a low rank space projection system comprises a low rank space variable projection system operating on the processor and coupled to the transformer system, the low rank space variable projection system configured to convert input variable data into low rank space input variable data.

19. The system of claim 15 wherein the a low rank space projection system comprises a low rank space weight projection system operating on the processor and coupled to the transformer system, the low rank space weight projection system configured to convert input weight data into low rank space input weight data.

20. The system of claim 15 further comprising a reverse projection variable system operating on the processor and configured to receive the low rank space output data and to perform a reverse projection variable process on the low rank space output data to generate reverse projected variable output data.
